(19) United States
(12) Patent Application Publication
(10) Pub. No.: US 2005/0013680 A1
(43) Pub. Date: Jan. 20, 2005

(54) Screws and methods of driving a screw into a workpiece

(76) Inventors: Steve Karaga, Lawrenceville, CA (US); Rupak Kanji Ved, Dubai (AE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/824,447

(22) Filed: Apr. 14, 2004

Related U.S. Application Data
(60) Provisional application No. 60/488,861, filed on Jul. 18, 2003.

(51) Int. Cl. F16B 25/00

(52) U.S. Cl. 411/386

(57) ABSTRACT

The present disclosures are apparatus and methods for driving a screw into a workpiece using a nail gun. In one embodiment, a screw can be driven into a workpiece using a nail gun such that a head of the screw is embedded to the workpiece. In a preferred embodiment, the screw comprises a point section that has a point with a tip angle of approximately 35-37°. The point section is coupled to a thread section. The thread section has threads along the thread section in which the beginning of the first thread is fully formed adjacent to the point section. The thread further has thread having a thread angle of approximately 60-63°. A head section is coupled to the thread section and the head section has a frustoconical head. The head has at least one nib on the side of the head. The frustoconical head and the nib on the side of the head enable the screw to withstand the operating pressure of the nail gun.

### CROSS-REFERENCE TO RELATED APPLICATION

This application claims priority to copending U.S. provisional application entitled, “Ballistic Screw,” having Ser. No. 60/488,861 filed Jul. 18, 2003, which is entirely incorporated herein by reference

### TECHNICAL FIELD

The present disclosure relates to screws, and more particularly, the disclosure relates to screws that can be driven into a workpiece using a nail gun.

### BACKGROUND

Typically, screws are rotationally driven into a workpiece by either a screwdriver or a rotary screw gun. Nails, on the other hand, are driven into a workpiece by either a hammer or a nail gun. The nail gun has decreased the amount of time needed to complete projects requiring nails. Even with the rotary screw gun, projects requiring screws still take more time to complete than projects requiring nails using the nail gun.

From the above, it can be appreciated that it would be desirable to have an apparatus and method for driving a screw into a workpiece using a nail gun.

### SUMMARY

The present disclosures are apparatus and methods for driving a screw into a workpiece using a nail gun. In one embodiment, a screw can be driven into a workpiece using a nail gun such that a head of the screw is embedded into the workpiece. In a preferred embodiment, the screw comprises a point section that has a point in a shape of a four-sided pyramid with a tip angle of approximately 35-37°. The point section is coupled to a thread section. The thread section has threads with a thread angle of approximately 60-63°. A head section is coupled to the thread section. The head section has a frustoconical head, which has at least one nib on the side of the head. The frustoconical head and the nib on the side of the head enable the screw to withstand the operating pressure of the nail gun.

The invention can also be construed as providing a method for driving a screw into a workpiece. The method comprises loading at least one screw into a nail gun and driving the at least one screw into the workpiece using the nail gun such that a head of the screw is embedded to the workpiece.

### BRIEF DESCRIPTION OF THE DRAWINGS

The disclosed apparatus and methods can be better understood with reference to the following drawings. The components in the drawings are not necessarily to scale.

FIG. 1 is side view of an embodiment of a screw.

FIG. 2 is an exploded view of a point section and a partial view of a thread section of the screw as shown in FIG. 1.

FIG. 3 is a top view of a head section of the screw as shown in FIG. 1.

FIG. 4 is an embodiment of the screw shown in FIG. 1 being collated.

FIG. 5 is an exploded view of two screws shown in FIG. 4 being collated.

FIG. 6 is a cross-section view along line AA of FIG. 5.

FIG. 7 is a cross-section view along line BB of FIG. 5.

FIG. 8 is an embodiment of a nail gun loaded with collated screws shown in FIG. 5.

FIG. 9 illustrates an exemplary embodiment of a method for driving a screw into a workpiece.

### DETAILED DESCRIPTION

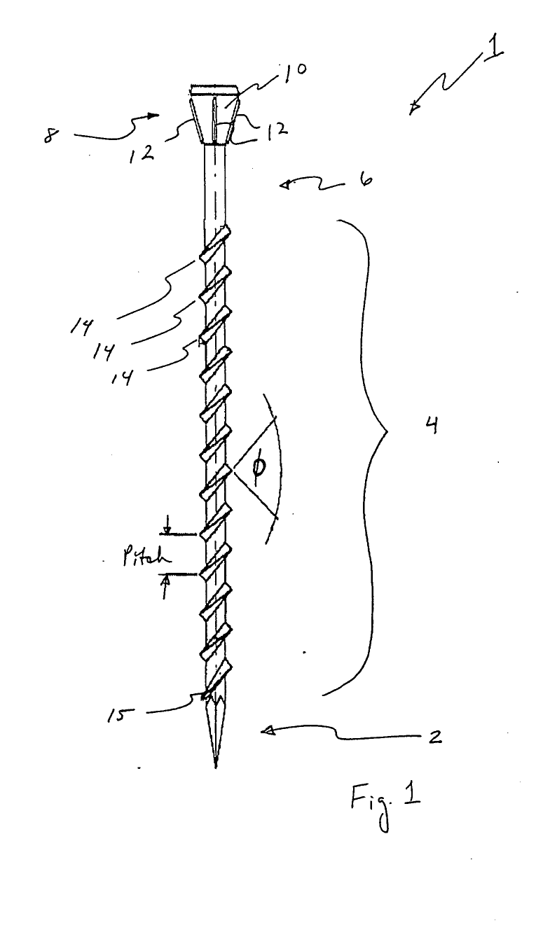

Disclosed herein are apparatus and methods to which a screw can be driven into a workpiece using a nail gun. In particular, the screw has a frustoconical head that has at least one nib on the side of the head. The frustoconical head and the nib on the side of the head enable the screw to withstand the operating pressure of the nail gun. Further, the screw has a point with a tip angle of approximately 35-37° that assists the driveability of the screw without splintering the workpiece. Example apparatus are first discussed with reference to the figures. Although the apparatus are described in detail, the apparatus are provided for purposes of illustration only and various modifications are feasible. After the exemplary apparatus have been described, examples of operations are provided to explain the manners in which the screws are driven into the workpiece. Referring now in more detail to the figures in like reference numerals identify corresponding parts, FIG. 1 is a side view of an embodiment of a screw that can be driven into a workpiece using a nail gun. As indicated in this figure, the screw 1 generally comprises a point section 2, a thread section 4, an unthread section 6, and a head section 8. The point section 2 is coupled to the thread section 4, which the thread section 4 is coupled to the unthread section 6. The head section 8 is coupled to the unthread section 6. The head section 8 has a frustoconical head 10 that has at least one nib 12 on the side of the frustoconical head 10. FIG. 1 shows three nibs 12 on the side of the frustoconical head 10. However, when viewed from the top, as shown in FIG. 3, the screw 1 includes four nibs 12 that are equally spaced at approximately 90° apart on the side of the head 10.

The frustoconical head 10 and the nib 12 on the side of the head 10 enable the screw 1 to withstand the operating pressure of the nail gun when the screw is driven into the workpiece.

With further reference to FIG. 1, the thread section 4 includes threads 14 along the thread section 4 in which the beginning of the first thread 15 is fully formed adjacent to the point section 2. The thread includes a thread angle Φ of approximately 60-63° and a pitch of approximately 0.111-118 inches. The thread angle Φ and the pitch enable the screw 1 to be driven into the workpiece using the nail gun without damaging the thread of the screw. In addition, the thread angle Φ of the thread enables the screw 1 to be easily driven into the workpiece using the nail gun and to require extra force for withdrawing the screw from the workpiece.

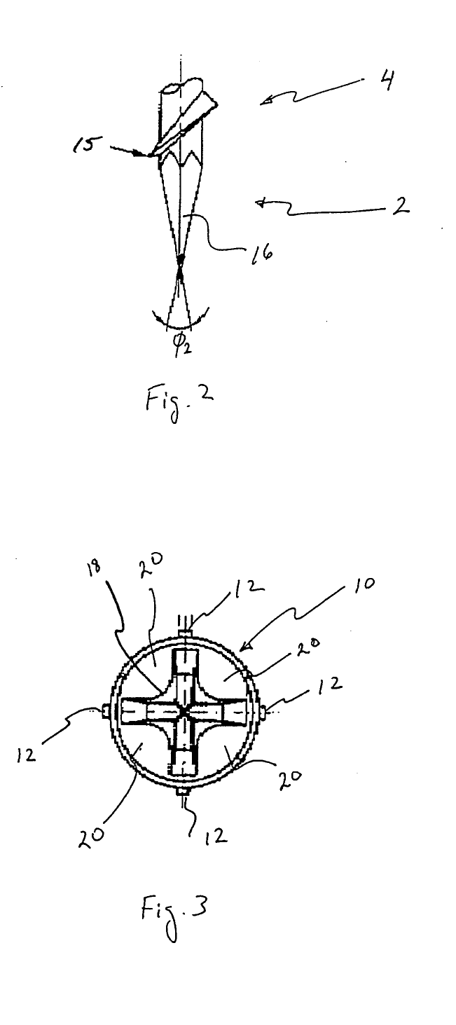

FIG. 2 is an exploded view of the point section 2 and partial view of the thread section 4. The point section 2 includes a point 16 having a tip angle Φ₂ of approximately 35-37°. The point 16 is preferably in a shape of a four-sided pyramid. In an alternative embodiment, the point 16 can be in a shape of a cone, a three-sided pyramid and/or a five-sided pyramid. In all embodiments, the tip angle Φ₂ of the point 16 assists the driveability of the screw 1 without splintering the workpiece, particularly wood. The tip angle Φ₂ also insures that the screw 1 travels into the workpiece without damaging the threads 14. FIG. 2 further shows that the beginning of the first thread 15 is fully formed adjacent to the point section 2.

FIG. 3 is a top view of the head section 8. The head section 8 preferably includes a Phillips head recess 18. In an alternative embodiment, the head section 8 can include a slot recess for use with a flat-head screw driver, a hexagonal recess for use rotationally with an Allen wrench, or other geometrical shaped recesses for use with tools that can drive or withdraw the screw from a workpiece. Referring back to FIG. 3, the head section 8 further includes surfaces 20 that have continuous convex radial shape. The head section 8 has a frustoconical head 10 that includes nibs 12 on the side of the head 10 and is preferably equal spaced at approximately 90° apart from each other. In an alternative embodiment, the frustoconical head 10 can include two, three, five, or six nibs being equal spaced apart from each other.

The screw 1 is preferably made of steel; however, it should be noted that screw could be made of other metals, such as brass. The screw 1 can be coated with a phosphate to prevent corrosion on the surface of the screw 1. The screw 1 can also be coated with zinc plating to provide corrosion resistance and decorative finish. Zinc plating covers the complete surface of the screw 1 with metallic zinc deposition. The process includes the stage of degreasing, anodic cleaning, acid pickling, zinc plating and cromate passivation.

The screw 1 may further be coated with a drive catalyst that assists the screw 1 to be driven into the workpiece and provides bonding between the screw 1 and the workpiece. The drive catalyst can be applied to the screw 1 in the form of smooth film. The drive catalyst enables the screw 1 to penetrate into the workpiece with extra momentum and lubrication. Because the drive catalyst provides extra momentum and lubrication that increases penetration into the workpiece, the screw 1 requires extra force for withdrawing the screw 1 from the workpiece as compared to uncoated screws.

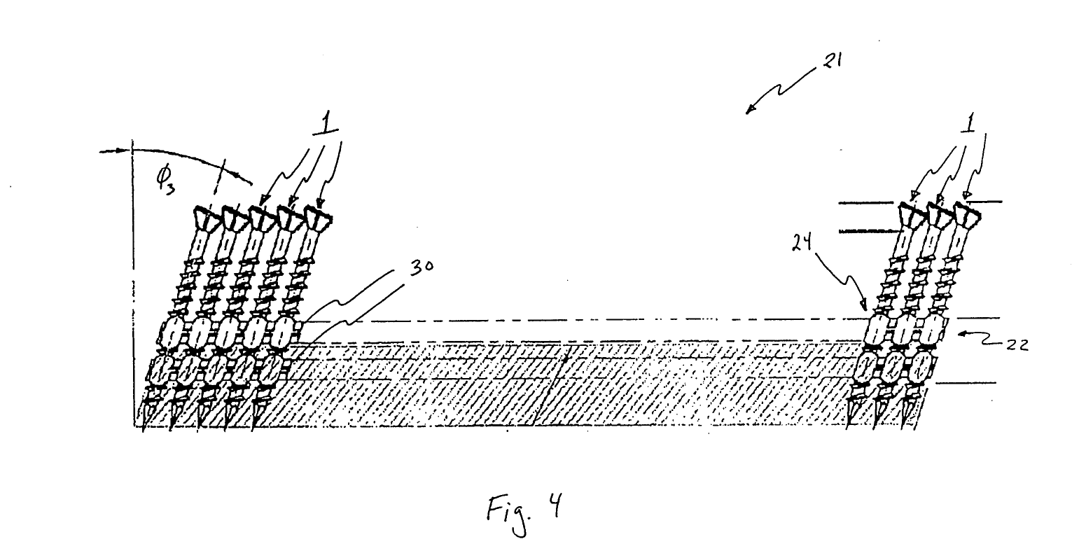

FIGS. 4-6 illustrate an embodiment of the screws 1 that are collated into a strip of collated screws. Referring to FIG. 4, the screws 1 are inserted into the strip 22, which comprises carriers 24 and breakable portions 30. Preferably, the strip 22 is made of plastic and enables the screws to be collated. Further, the strip 22 is designed to place the screws 1 at an angle Φ₃ of approximately 20-22° along the strip 22. This angle enables the collated screws 21 to be used with the nail gun, preferably a pneumatic nailer made by the Hitachi model number NR23A. It should be noted that the collated screws 21 can be driven by any nail gun other than pneumatic nailers, such as spring loaded nail guns, electromagnetic nail guns, combustion nail guns, etc. Further, the collated screws 21 can be constructed to place the screws 1 at a different angle so that when the collated screws are loaded into a load mechanism of a particular nail gun, the collated screws 21 can be driven into the workpiece parallel with the direction of the force exerted by the nail gun.

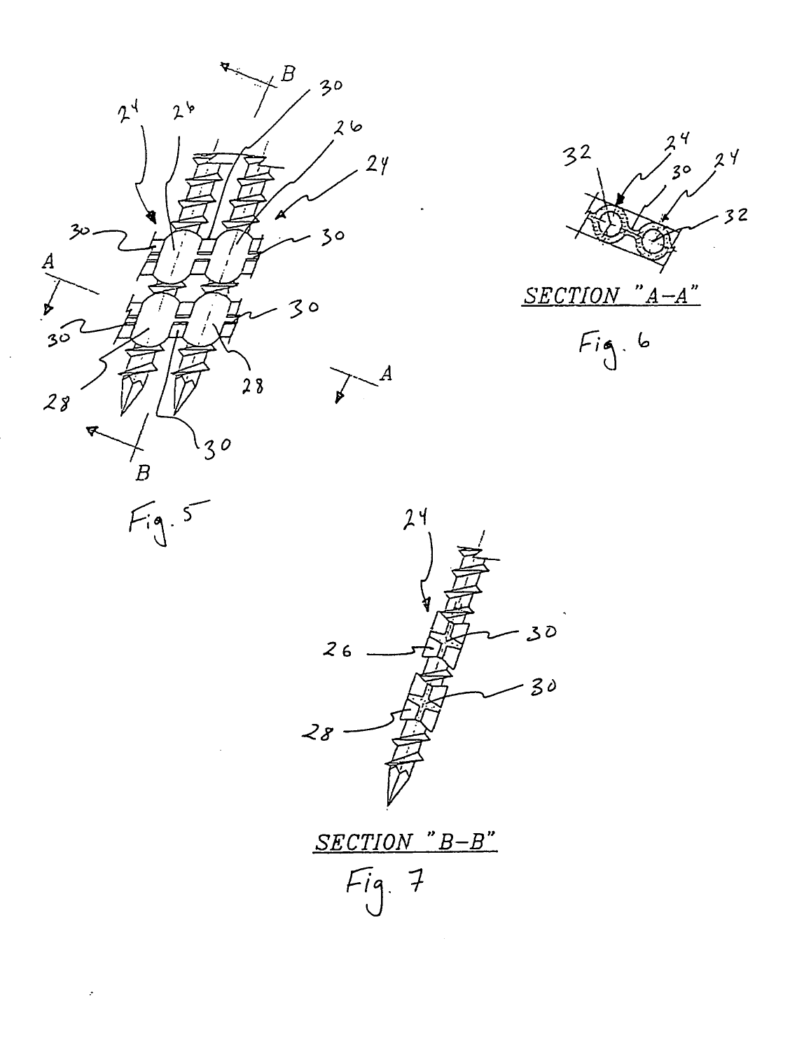

FIG. 5 illustrates an exploded view of two screws collated as shown in FIG. 4. Referring to FIG. 5, the carrier 24 comprises an upper sleeve 26 and a lower sleeve 28. The carriers 24 are linked together via breakable portion 30. The breakable portion 30 links the carriers 24 together and places the screws 1 at a preferably angle Φ₃ of approximately 20-22° along the strip 22. Further, the carrier 24 breaks away from the screw and the adjacent carrier 24 when the screw is being driven by the nail gun. FIG. 6 is a cross-section view along line AA of FIG. 5. The carrier 24 has a circular cross section that is connected to another carrier 24 via breakable portion 30. Alternatively, the carrier 24 can have a cross section in other geometric shapes, e.g., triangular, rectangular, hexagonal, etc. The carrier 24 further includes an opening 32 that receives the screw 1. FIG. 7 is a cross-section view along line BB of FIG. 5. The breakable portion 30 has a T cross-section that connects the carriers 24 together. Alternatively, the breakable portion can have a cross-section in other shapes, e.g., circular, triangular, “H”, “I”, etc.

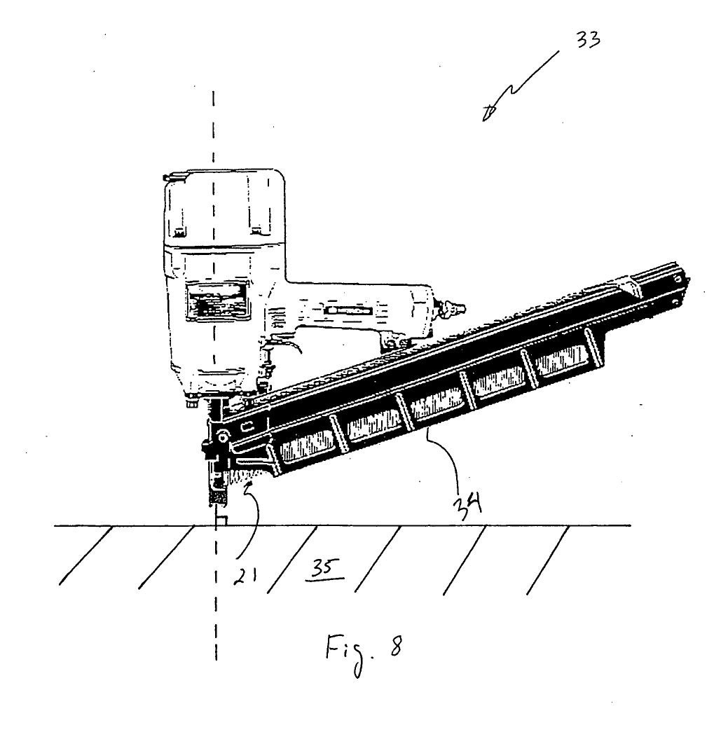

FIG. 8 illustrates an example of a nail gun 33 loaded with collated screws 21. The collated screws 21 are loaded into a load mechanism 34 of the nail gun 33. The load mechanism 34 and the collated screws 21 are at an angle to enable the nail gun 33 to drive the screws into a workpiece 35 parallel to the direction of the force exerted by the nail gun 33.

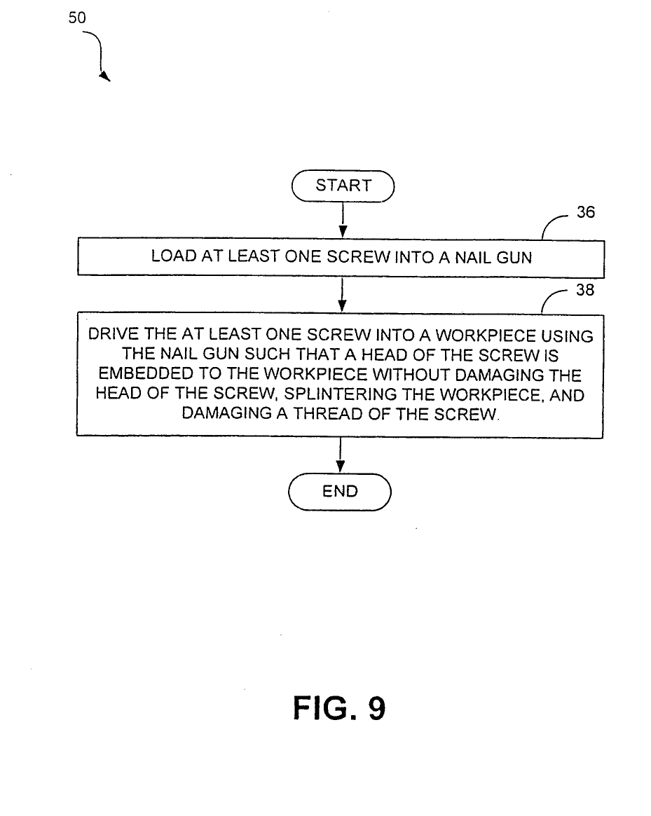

FIG. 9 illustrates an exemplary embodiment of a method 50 for driving a screw into a workpiece. Beginning with block 36, the method comprises loading at least one screw into a nail gun. In block 38, the screw is driven into a workpiece using the nail gun such that a head of the screw is embedded into the workpiece. The screw can be driven into the workpiece using the nail gun without damaging the head of the screw, without splintering the workpiece, and without damaging a thread of the screw.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A screw that can be driven into a workpiece using a nail gun such that a head of the screw is embedded into the workpiece, the screw comprising:
a point section that has a point shaped in a four-sided pyramid with a tip angle of approximately 35-37°;
a thread section being coupled to the point section, the thread section having threads along the thread section, the beginning of the first thread being fully formed adjacent to the point section, the thread having a thread angle of approximately 60-63°; and
a head section being coupled to the thread section, the head section having a frustoconical head, the head having at least one nib on the side of the head, wherein the frustoconical head and the at least one nib on the side of the head enable the screw to withstand the operating pressure of the nail gun.

2. The screw as defined in claim 1, wherein the screw is coated with a phosphate to prevent corrosion on the surface of the screw.

3. The screw as defined in claim 1, wherein the screw further comprises an unthread section, the unthread section being coupled to the point section and the thread section.

4. The screw as defined in claim 1, wherein the screw is coated with the drive catalyst to assist the screw to be driven into the workpiece and provide bonding between the screw and the workpiece.

5. The screw as defined in claim 1, wherein the thread having a pitch of approximately 0.111-118 inches.

6. The screw as defined in claim 1, wherein the frustoconical head having four equal spaced nibs at approximately 90° apart on the side of the head.

7. The screw as defined in claim 1, wherein the screws are collated to be used with a nail gun.

8. A screw comprising:
a point section;
a thread section coupled to the point section;
a head section coupled to the thread section, the head section having a frustoconical head, the head having at least one nib on the side of the head.

9. The screw as defined in claim 8, wherein the point section has a point with a tip angle of approximately 35-37°.

10. The screw as defined in claim 8, wherein the thread section has threads along the thread section, the beginning of the first thread being fully formed adjacent to the point section.

11. The screw as defined in claim 8, wherein the thread section has threads with a thread angle of approximately 60-63°.

12. The screw as defined in claim 8, wherein the screw is coated with a phosphate to prevent corrosion on the surface of the screw.

13. The screw as defined in claim 8, wherein the thread section has threads with a pitch of approximately 0.111-0.118 inches.

14. The screw as defined in claim 8, wherein the frustoconical head has four equal spaced nibs at approximately 90° apart on the side of the head.

15. The screw as defined in claim 8, wherein the screw further comprises an unthread section, the unthread section being coupled to the point section and the thread section.

16. The screw as defined in claim 9, wherein the screw can be driven into a workpiece via a nail gun such that the frustoconical head is embedded into the workpiece.

17. A screw comprising:
a point section having a point with a tip angle of approximately 35-37°;
a thread section coupled to the point section; and
a head section coupled to the thread section, the head section being capable of withstanding the operating pressure of a nail gun.

18. The screw as defined in claim 17, wherein the head section has a frustoconical head that has at least one nib on the side of the head.

19. The screw as defined in claim 17, wherein the thread section has threads along the thread section, the beginning of the first thread being fully formed adjacent to the point section.

20. The screw as defined in claim 17, wherein the thread section has threads with a thread angle of approximately 60-63°.

21. The screw as defined in claim 17, wherein the screw is coated with a phosphate to prevent corrosion on the surface of the screw.

22. The screw as defined in claim 17, wherein the thread section has threads with a pitch of approximately 0.111-118 inches.

23. The screw as defined in claim 18, wherein the frustoconical head has four equal spaced nibs at approximately 90° apart on the side of the head.

24. The screw as defined in claim 17, wherein the screw further comprises an unthread section, the unthread section being coupled to the point section and the thread section.

25. The screw as defined in claim 18, wherein the screw can be driven into a workpiece via the nail gun such that the frustoconical head is embedded into the workpiece.

26. The screw as defined in claim 17, wherein the point is in the shape of one of a four-sided pyramid and a cone.

27. A method for driving a screw into a workpiece, the method comprising the steps of:
loading at least one screw into a nail gun; and
driving the at least one screw into the workpiece using the nail gun such that a head of the screw is embedded to the workpiece.

28. The method as defined in claim 27, further comprising driving the screw using the nail gun without damaging the head of the screw.

29. The method as defined in claim 27, further comprising driving the screw into the workpiece without splintering the workpiece.

30. The method as defined in claim 27, further comprising driving the screw into the workpiece without damaging a thread of the screw.
